(19) United States
(12) Patent Application Publication
(10) Pub. No.: US 2015/0017328 A1
(43) Pub. Date: Jan. 15, 2015

(54) SURFACE TREATMENT APPARATUS AND METHOD FOR NUFACTURING SURFACE-TREATED SUBSTRATE

(71) Applicant: IBIDEN CO., LTD., Ogaki-shi (JP)

(72) Inventors: Takashi Nakane, Ogaki-shi (JP); Yoshihiro Nishio, Ogaki-shi (JP); Yoshiki Kawai, Ogaki-shi (JP); Teruyoshi Hisada, Ogaki-shi (JP); Koya Ozeki, Ogaki-shi (JP); Mitsutaka Naitoh, Ogaki-shi (JP); Yutaka Shichi, Ogaki-shi (JP)

(73) Assignee: IBIDEN CO., LTD., Ogaki-shi (JP)

(21) Appl. No.: 14/331,319

(22) Filed: Jul. 15, 2014

(30) Foreign Application Priority Data
Jul. 15, 2013 (JP) 2013-147159

(51) Int. Cl. B05B 15/08; B05B 1/14; B05B 7/08; B05B 13/06; B05B 15/12; B05B 1/02; B05B 13/02

(52) U.S. Cl. CPC B05B 15/08; B05B 1/02; B05B 1/14; B05B 13/0221; B05B 13/069; B05B 15/1292; B05B 15/1214; B05B 7/08
USPC 427/236; 118/300; 118/314; 427/424

(57) ABSTRACT

A surface treatment apparatus includes a treatment vessel which contains a treatment solution, a transfer device which transfers a substrate through an interior portion of the treatment vessel in an in-plane direction of the substrate, and a jet device which is positioned in the interior portion of the treatment vessel and jets the treatment solution onto a surface of the substrate such that the surface of the substrate is treated with the treatment solution in the interior portion of the treatment vessel. The jet device has a nozzle hole which jets the treatment solution in a jet direction set parallel or diagonal with respect to the substrate surface.

### CROSS-REFERENCE TO RELATED APPLICATIONS

The present application is based upon and claims the benefit of priority to Japanese Patent Application No. 2013-147159, filed Jul. 15, 2013, the entire contents of which are incorporated herein by reference.

### BACKGROUND OF THE INVENTION

1. Field of the Invention

The present invention relates to a surface treatment apparatus to perform surface treatment on a substrate surface and to a method for manufacturing a surface-treated substrate obtained by performing surface treatment on a substrate surface. More specifically, the present invention relates to a surface treatment apparatus that performs surface treatment on a substrate by jetting a treatment solution on a substrate surface, and to a method for manufacturing a surface-treated substrate.

2. Description of Background Art

A multilayer wiring board may be manufactured by laminating multiple conductive layers having insulation layers disposed in between and each having a wiring pattern. In addition, in steps of manufacturing a wiring board, various surface treatments such as desmearing, soft etching and plating may be performed on a substrate during the manufacturing process. Surface treatment on a substrate is performed by, for example, jetting a treatment solution on main surfaces, which are both ends in a lamination direction of the substrate, while transferring the substrate using multiple paired transfer rollers positioned along the transfer route (see, for example, JP2006-32394A). The entire contents of this publication are incorporated herein by reference.

### SUMMARY OF THE INVENTION

According to one aspect of the present invention, a surface treatment apparatus includes a treatment vessel which contains a treatment solution, a transfer device which transfers a substrate through an interior portion of the treatment vessel in an in-plane direction of the substrate, and a jet device which is positioned in the interior portion of the treatment vessel and jets the treatment solution onto a surface of the substrate such that the surface of the substrate is treated with the treatment solution in the interior portion of the treatment vessel. The jet device has a nozzle hole which jets the treatment solution in a jet direction set parallel or diagonal with respect to the substrate surface.

According to another aspect of the present invention, a method for producing a surface-treated substrate includes transferring a substrate in an in-plane direction through a treatment solution contained in an interior portion of a treatment vessel, and jetting the treatment solution onto a surface of the substrate in the interior portion of the treatment vessel such that the treatment solution is jetted in a jet direction which is set parallel or diagonal with respect to the surface of the substrate.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a view schematically showing the structure of a surface treatment apparatus according to an embodiment of the present invention;

FIG. 2 is a view illustrating a jet nozzle of the surface treatment apparatus;

FIG. 3 is a view illustrating the flow of a plating solution inside a bottomed hole when the plating solution is jetted perpendicular to a main surface of a substrate;

FIG. 4 is a view illustrating the flow of a plating solution inside a bottomed hole when the plating solution is jetted diagonally to a main surface of a substrate;

FIG. 5 is a view illustrating a conventional jet nozzle; and

FIG. 6 is a graph showing deposit speeds of plating using the jet nozzle of the embodiment and a conventional jet nozzle respectively.

### DETAILED DESCRIPTION OF THE EMBODIMENTS

The embodiments will now be described with reference to the accompanying drawings, wherein like reference numerals designate corresponding or identical elements throughout the various drawings.

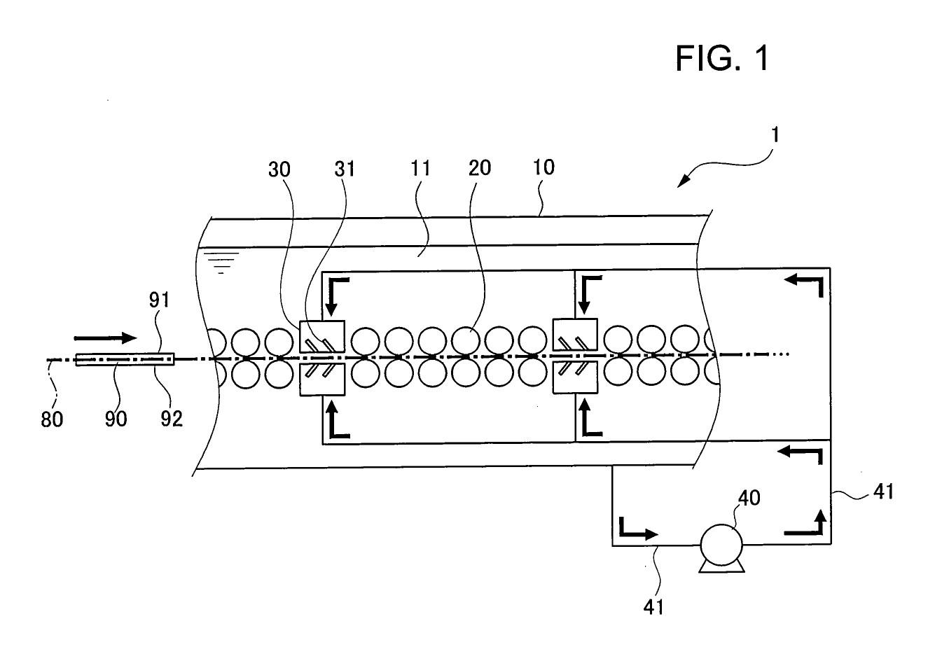

FIG. 1 is a view schematically showing the structure of a surface treatment apparatus according to the present embodiment. Surface treatment apparatus 1 of the present embodiment is provided with plating solution 11 stored in a treatment vessel. Surface treatment apparatus 1 is for performing chemical copper plating on a surface of substrate 90 using plating solution 11. Solutions conventionally used for chemical copper plating are available for plating solution 11. Substrate 90 is a laminate formed by laminating multiple conductive layers having insulation layers disposed in between and each having a wiring pattern. In FIG. 1, main surfaces of substrate 90, which are both ends in a lamination direction, are shown as main surfaces (91, 92). Substrate 90 will subsequently be a wiring board to be mounted on an electronic device or the like when upper layers are further formed on main surfaces (91, 92).

In addition, multiple transfer rollers 20 are provided in treatment vessel 10; transfer rollers 20 are paired rollers for transferring substrate 90 along transfer route 80 from left to right as seen in FIG. 1. Multiple transfer rollers 20 are positioned in such a way that paired rollers facing each other are arrayed along transfer route 80 of substrate 90. Transfer rollers 20 sandwich main surfaces (91, 92) and rotate to transfer substrate 90. Surface treatment apparatus 1 further includes multiple jet nozzles 30 positioned above and below transfer route 80 in treatment vessel 10. Jet nozzles 30 are used to jet plating solution 11 onto main surfaces (91, 92) of substrate 90, which is transferred along transfer route 80. Thus, jet nozzles 30 have nozzle holes 31 for jetting plating solution 11 in portions that face main surfaces (91, 92) of substrate 90.

Also, surface treatment apparatus 1 has flow channel 41 that connects treatment vessel 10 and jet nozzle 30 as shown in FIG. 1. Pump 40 is connected to flow channel 41. Pump 40 is used for pumping plating solution 11 from treatment vessel 10 into flow channel 41 and pumping it out toward jet nozzle 30. Plating solution 11 is pumped out to flow channel 41 by pump 40 and jetted from nozzle hole 31 of jet nozzle 30.

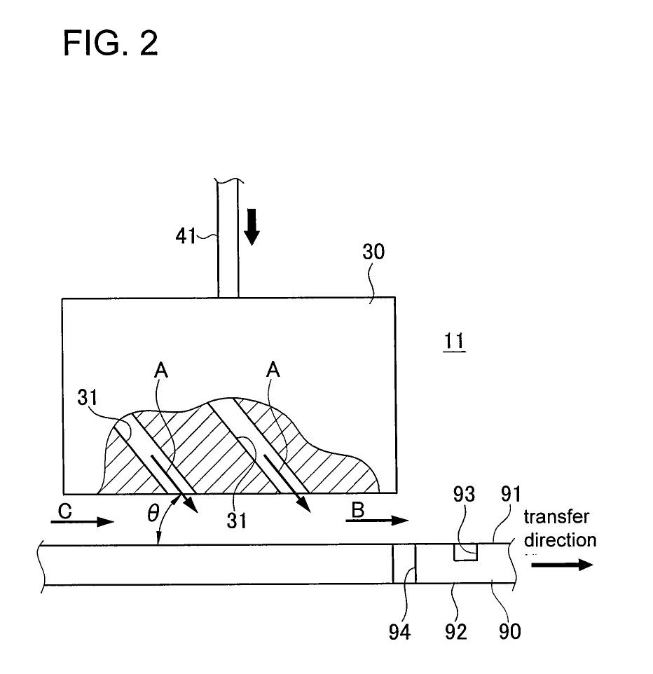

Of the jet nozzles 30 shown in FIG. 1, FIG. 2 shows an enlarged view of a jet nozzle 30 for jetting plating solution 11 onto the main surface 91 side of substrate 90. In addition, nozzle holes 31 are shown in a partial cross section of jet nozzle 30 in FIG. 2. Jet nozzle hole 31 of the present embodiment is shaped as a slit continuously open in a width direction, which is perpendicular to the transfer direction of substrate 90 (the direction toward the depth in FIGS. 1 and 2). Moreover, the length of nozzle hole 31 in a width direction of substrate 90 is approximately the same as the length of substrate 90. Also, arrow (A) in FIG. 2 shows a direction of a flow that is the fastest among the flows of plating solution 11 jetted through jet nozzle 30. As shown by arrow (A) in FIG. 2, jet nozzle 30 of the present embodiment jets plating solution 11 in a direction not perpendicular to main surface 91 of substrate 90, but diagonal to main surface 91. Namely, jet angle (θ) of jet direction (A) of plating solution 11 jetted from nozzle hole 31 of jet nozzle 30 makes an acute angle to main surface 91 of substrate 90. Moreover, jet direction (A) of plating solution 11 from jet nozzle 30 is set from the upstream toward the downstream in a transfer direction of substrate 90. In addition, jet direction (A) of the present embodiment is parallel to the transfer direction of substrate 90 when seen from a direction perpendicular to main surface 91.

As shown in FIG. 2, bottomed hole 93 and penetrating hole 94, bored in a thickness direction, are formed in various portions of substrate 90. Bottomed hole 93 and penetrating hole 94 are formed by laser processing or drill processing. Bottomed hole 93 is open only at main surface 91 of substrate 90 and does not penetrate through substrate 90. Penetrating hole 94 penetrates through substrate 90 and opens on both main surface 91 and main surface 92. As described above, substrate 90 is formed by laminating multiple conductive layers and insulation layers. By forming a plated layer on the inner-wall surface or the like, bottomed hole 93 and penetrating hole 94 will each subsequently become a via that electrically connects wiring patterns positioned in different conductive layers of substrate 90.

Surface treatment apparatus 1 is used to perform plating treatment on main surfaces (91, 92) of substrate 90 as well as on inner-wall surfaces or the like of bottomed hole 93 and penetrating hole 94. Since jet direction (A) of plating solution 11 from jet nozzle 30 is inclined toward main surface 91 of substrate 90, surface treatment apparatus 1 is capable of forming a plated layer with uniform and sufficient thickness in a short period of time on main surface 91 of substrate 90. Furthermore, a plated layer with a uniform and sufficient thickness is also formed on inner-wall surfaces or the like of bottomed hole 93 and penetrating hole 94 in a short period of time. The following provides a detailed description of how such effects are achieved by using jet nozzle 30 of the present embodiment.

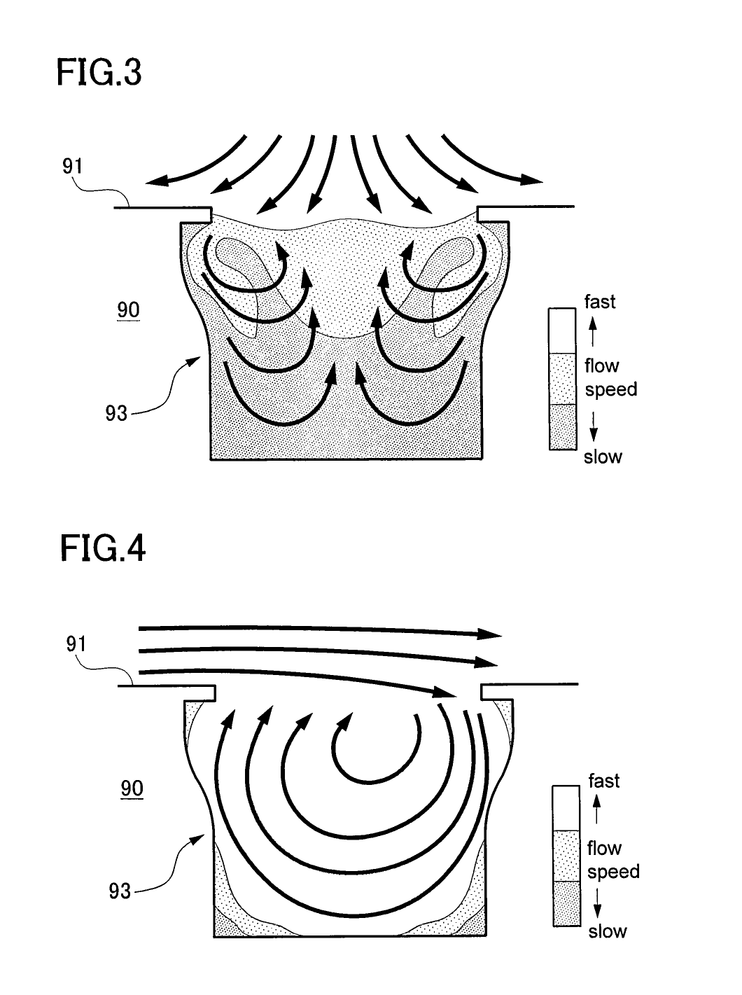

First, simulation results are shown regarding the flow of plating solution 11 on main surface 91 of substrate 90 with respect to the flow of plating solution 11 inside bottomed hole 93 which opens on main surface 91. FIG. 3 is a view showing the flow and flow speed of plating solution 11 inside bottomed hole 93 at a jetted position when plating solution 11 is jetted perpendicular to main surface 91 of substrate 90. Namely, FIG. 3 shows an example where the jet angle (θ) is set at 90 degrees and plating solution 11 is jetted directly from above the opening portion of bottomed hole 93.

As shown in FIG. 3, it is found that inside bottomed hole 93, the flow of plating solution 11 is slower as it goes closer to the hole bottom, causing plating solution 11 to stagnate. That is thought to be because in the vicinity of the opening portion, the flow of plating solution 11 jetted perpendicular to main surface 91 collides with the flow of plating solution 11 flowing out from the inside of bottomed hole 93 toward the outside. Therefore, plating may not be conducted properly on the inner-wall and bottom surfaces of bottomed hole 93 where plating solution 11 is stagnant. Distribution of the components of plating solution 11 becomes uneven when it is stagnant, causing the deposit speed of the plating to be slower than the deposit speed on the surface in contact with plating solution 11, which is flowing well. Here, as shown in FIG. 3, on main surface 91 of substrate 90, plating solution 11 jetted perpendicular to main surface 91 is flowing well to a certain degree. Namely, plating solution 11 is flowing along main surface 91 of substrate 90.

By contrast, FIG. 4 is a view showing the flow and flow speed of plating solution 11 inside bottomed hole 93 at a jetted position when plating solution 11 is jetted at a jet angle (θ) of 45 degrees with respect to main surface 91 of substrate 90. Namely, plating solution 11 is jetted from the upper left of bottomed hole 93 toward the opening portion of bottomed hole 93 in FIG. 4. Here, the flow speed and flow volume of plating solution 11 jetted in FIG. 4 are set the same as those in FIG. 3.

As shown in FIG. 4, the flow of plating solution 11 jetted at a jet angle of 45 degrees is excellent both on main surface 91 of substrate 90 and inside bottomed hole 93. Namely, on main surface 91 of substrate 90, plating solution 11 flows along main surface 91 at a fast flow speed. Also, inside bottomed hole 93 as well, the flow going into bottomed hole 93 and the flow going out of bottomed hole 93 do not collide, and the flow of plating solution 11 thereby circulates. Moreover, plating solution 11 inside bottomed hole 93 also flows at a fast flow speed. Thus, in FIG. 4, plating treatment using plating solution 11 is properly conducted on the inner-wall and bottom surfaces of bottomed hole 93. Namely, the deposit speed of plating is fast on the inner-wall and bottom surfaces of bottomed hole 93, and the plated layer to be formed has a uniform thickness. Therefore, from FIGS. 3 and 4, in order to keep plating solution 11 flowing inside bottomed hole 93 of substrate 90 and to perform plating on its inner-wall surface and the like, it is desired for plating solution 11 to generate a flow along main surface 91 of substrate 90 where bottomed hole 93 opens. Furthermore, when the jet angle (θ) was set at 0 degree so that plating solution 11 was jetted parallel to main surface 91 of substrate 90, substantially the same results as shown in FIG. 4 were obtained. That is because plating solution 11 jetted parallel to main surface 91 of substrate 90 is dispersed or the like, generating a flow that goes into bottomed hole 93.

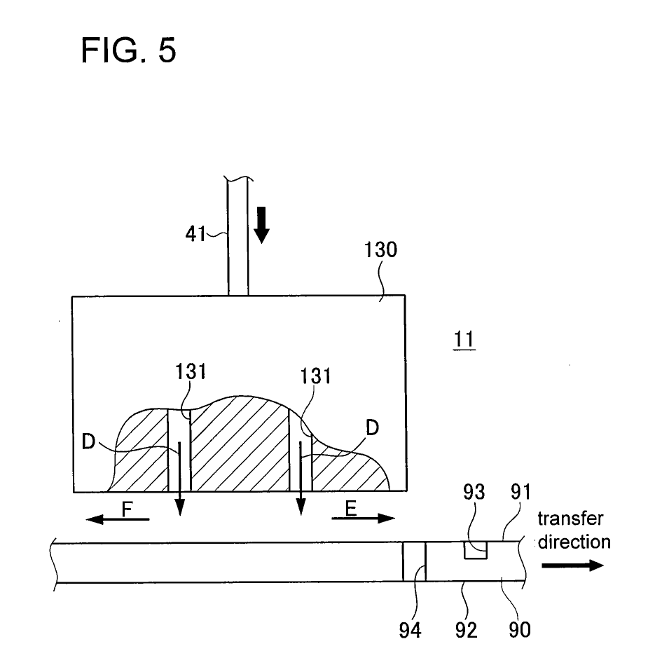

The following is a description of the results obtained by measuring the flow speeds of plating solution 11 which was jetted respectively using jet nozzle 30 of the present embodiment and a conventional jet nozzle. FIG. 5 is a view showing conventional nozzle 130. The main jet direction of conventional jet nozzle 130 is shown by arrow (D) in FIG. 5. Namely, jet nozzle 130 has nozzle hole 131 which jets plating solution 11 perpendicular to main surface 91 of substrate 90. Then, when plating solution 11 is jetted from jet nozzle 130, a flow shown by arrow (E) and a flow shown by arrow (F) in FIG. 5 are generated along main surface 91 of substrate 90.

With respect to the transfer direction of substrate 90, flow (E) is in a downstream direction, and flow (F) is in an upstream direction. Flow (E) and flow (F) of plating solution 11 generated by conventional jet nozzle 130 cause the flow shown in FIG. 4 to be generated inside bottomed hole 93 at the jet position. Because of such a flow, a plated layer is formed on the inner-wall surface and the like of bottomed hole 93. As described with reference to FIG. 3, the flow of plating solution 11 inside bottomed hole 93 does not flow well when it is in the vicinity of being directly under nozzle hole 131 of jet nozzle 130. In addition, when the speeds of flow (E) and flow (F) by jet nozzle 130 were measured, both were found to be 10% or less of the flow speed at the outlet of nozzle hole 131 of jet nozzle 130.

By contrast, using jet nozzle 30 of the present embodiment shown in FIG. 2, when plating solution 11 is jetted in the direction of arrow (A), flows (B, C) from the upstream side toward the downstream side in the transfer direction of substrate 90 are generated along main surface 91 of substrate 90. Flow (B) is generated when plating solution 11 jetted by jet nozzle 30 in the direction of arrow (A) flows along main surface 91 of substrate 90. Flow (C) is generated when plating solution 11 jetted by jet nozzle 30 in the direction of arrow (A) flows in the direction of arrow (B) and has caused a negative pressure in the space between jet nozzle 30 and main surface 91 of substrate 90. Accordingly, a flow shown in FIG. 4 occurs inside bottomed hole 93 of substrate 90 because of flow (B) and flow (C) generated when plating solution 11 is jetted by jet nozzle 30 of the present embodiment. Because of such a flow, a plated layer is formed on the inner-wall surface or the like of bottomed hole 93.

Moreover, when the flow speed of flow (C) from jet nozzle 30 of the present embodiment was measured by setting a jet angle (θ) at 30 degrees, the flow speed was approximately 20% of the flow speed at the outlet of nozzle hole 31 of jet nozzle 30. Also, the flow speed of flow (B) was found to be no less than 30% of the flow speed at the outlet of nozzle hole 31 of jet nozzle 30. Namely, on both the upstream side and downstream side of the transfer direction of substrate 90, jet nozzle 30 of the present embodiment is capable of generating a faster flow of plating solution 11 along main surface 91 of substrate 90 than conventional jet nozzle 130. Moreover, since jet nozzle 30 of the present embodiment is capable of forming a faster flow of plating solution 11 on main surface 91 of substrate 90, a flow of plating solution 11 is generated in an even wider range of main surface 91 of substrate 90.

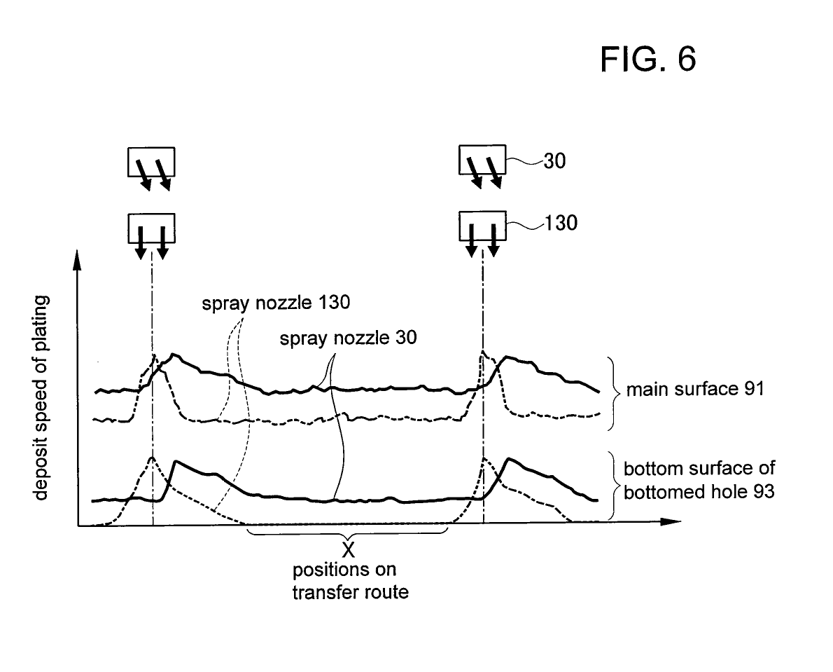

Next, FIG. 6 shows the results obtained by measuring the deposit speeds of plating using jet nozzle 30 of the present embodiment and conventional jet nozzle 130 respectively. In FIG. 6, the lateral axis indicates positions of substrate 90 on the transfer route; positions of jet nozzle 30 of the present embodiment and conventional nozzle 130 are each shown by a dotted line in the drawing. Also, the results in FIG. 6 were obtained by positioning jet nozzles (30, 130) at equal intervals on the transfer route of substrate 90 and by jetting plating solution 11 toward main surface 91 of substrate 90 being transferred on the transfer route. The deposit speed of plating by jet nozzle 30 of the present embodiment is shown by a solid line, and the deposit speed of plating by conventional jet nozzle 130 is shown by a broken line in FIG. 6. Furthermore, the deposit speed of plating on main surface 91 of substrate 90 and the deposit speed of plating at the bottom of bottomed hole 93 are both shown in FIG. 6.

As shown in FIG. 6, at a location near the jet position, the deposit speed of plating by conventional jet nozzle 130 is fast. That is because in a location near jet nozzle 130, plating solution 11 is not stagnant and distribution of its components is not uneven. However, the deposit speed of plating decreases significantly at a location farther away from jet nozzle 130. Especially, hardly any plating deposit is observed at the bottom surface of bottomed hole 93 in section (X) of jet nozzle 130 in FIG. 6.

As described above, flows (E, F) of plating solution 11 along main surface 91 of substrate 90 generated by using jet nozzle 130 are slow. Therefore, it is thought that hardly any flow of plating solution 11 is present on main surface 91 of substrate 90 at a location farther from jet nozzle 130. The deposit speed of plating is thereby thought to be decreased significantly on main surface 91 at a location farther from jet nozzle 130. Moreover, in section (X) farther from jet nozzle 130, there is no flow of plating solution 11 going into bottomed hole 93 because hardly any flow of plating solution 11 is present on main surface 91. Namely, in section (X), it is thought that the flow of plating solution 11 described with reference to FIG. 4 is not generated inside bottomed hole 93. By contrast, in the present embodiment, a peak of the deposit speed of plating is observed at a location slightly downstream of jet nozzle 30. That is because jet nozzle 30 of the present embodiment jets plating solution 11 toward the downstream side in a transfer direction of substrate 90. Then, in a section between jet nozzles 30, it is found that the deposit speed of plating is faster both at main surface 91 and at the bottom surface of bottomed hole 93 than when plating using conventional jet nozzle 130.

As described above, flows (B, C) of plating solution 11 along main surface 91 of substrate 90 generated by jet nozzle 30 of the present embodiment are fast. Therefore, it is thought that plating solution 11 is flowing on main surface 91 of substrate 90 even at a location farther from jet nozzle 30. Moreover, even at a location father from jet nozzle 30, it is thought that plating solution 11 flows into bottomed hole 93, thereby generating a flow inside bottomed hole 93 as shown in FIG. 4. Thus, it is found from FIG. 6 that when using jet nozzle 30 of the present embodiment, a plated layer with a uniform and sufficient thickness is formed in a short period of time on main surface 91 of substrate 90 and on the inner-wall and bottom surfaces of bottomed hole 93.

In the above, plating in bottomed hole 93 of substrate 90 was described. The same applies to penetrating hole 94. Namely, by using jet nozzle 30 of the present embodiment, a plated layer with a uniform and sufficient thickness is formed in a shorter period of time than when using conventional jet nozzle 130 on the inner-wall surface of penetrating hole 94 of substrate 90. When a faster flow of plating solution 11 along main surface 91 of substrate 90 is generated by jet nozzle 30 of the present embodiment, an excellent flow of plating solution 11 is generated inside penetrating hole 94. Also, in the above, descriptions were provided regarding upper main surface 91 of substrate 90 in surface treatment apparatus 1. However, the same applies to lower main surface 92. Namely, plating solution 11 is jetted diagonally onto main surface 92 using jet nozzle 30 arrayed below substrate 90 in FIG. 1. In addition, jet nozzle 30 positioned below substrate 90 also jets plating solution 11 downstream in a transfer direction of substrate 90. Therefore, a fast flow is generated along lower main surface 92 of substrate 90. Accordingly, a plated layer with a uniform and sufficient thickness is formed in a short period of time on main surface 92 and on the inner-wall surfaces of bottomed hole 93 and penetrating hole 94, which open on main surface 92. Moreover, jet nozzle 30 may also jet plating solution 11 parallel to main surface 91 of substrate 90. Namely, it is an option to set the jet angle (θ) of direction (A) for jetting plating solution 11 from jet nozzle 30 shown in FIG. 2 to be zero degree with respect to main surface 91 of substrate 90. That is because a fast flow is also generated along main surface 91 of substrate 90 by jetting plating solution 11 parallel to main surface 91 of substrate 90.

Furthermore, the thickness of a plated layer formed on a substrate in multiple examples each set under different conditions such as a jet angle (θ) of the jet nozzle of the present embodiment is confirmed. Conditions of each example are shown in Table 1 below. The comparative example shown in Table 1 was carried out by using a jet nozzle that jets a plating solution perpendicular to a main surface of a substrate as described above with reference to FIG. 5. Also, in each example and comparative example, conditions such as the number of jet nozzles and their intervals on the transfer route, flow speed and flow volume of a plating solution jetted from each nozzle, and transfer speed of the substrate in the treatment vessel were all set the same. In addition, in the examples, transfer rollers are of a type that transfer a substrate by sandwiching its main surfaces near the edges in a width direction. On the other hand, for the comparative example, transfer rollers are of a type that transfer a substrate by sandwiching the main surfaces of a substrate entirely in a width direction.

TABLE 1

| | | distance between jet | thickness of plated layer | |
|---|---|---|---|---|
| | jet | nozzle and main | main | bottom surface of |
| | angle θ | surface of substrate | surface | bottomed hole |
| example 1 | 75° | 4 mm | 1.2 | 1.4 |
| example 2 | 45° | 4 mm | 1.3 | 2.2 |
| example 3 | 30° | 4 mm | 1.4 | 2.6 |
| example 4 | 45° | 2 mm | 1.2 | 1.7 |
| example 5 | 30° | 2 mm | 1.3 | 2.1 |
| comparative | 90° | 4 mm | 1 | 1 |
| example | | | | |

Table 1 shows conditions of jet nozzles: the jet angle (θ) of the jet direction of a plating solution with respect to the main surface of a substrate, and the distance between a jet nozzle and the main surface of a substrate. Also, regarding the main surface of a substrate and the bottom surface of a bottomed hole in each example, the thicknesses of the plated layers shown in Table 1 are indicated by a ratio to the thickness of the plated layers in the comparative example.

As shown in Table 1, both on the main surface and on the bottom surface of a bottomed hole, the thickness of the plated layer formed on a substrate in each of the examples was greater than that of the comparative example. In addition, in each of the examples, it is found that a ratio of the thickness of a plated layer to the thickness in the comparative example is greater on the bottom surface of a bottomed hole than on the main surface. Also, as shown in Table 1, it is found that a smaller jet angle (θ) is preferred since such an angle has produced a plated layer with a greater thickness. Especially, it is found among the examples that a plated layer with a greater thickness is formed on the bottom surface of a bottomed hole when the jet angle (θ) is 45 degrees or smaller.

Therefore, it is found that a jet nozzle of the present embodiment is capable of generating an excellent flow of a plating solution on a main surface of a substrate and inside a bottomed hole. Moreover, it is found that the flow of a plating solution on a main surface and inside a bottomed hole is even better by setting the jet angle (θ) at 45 degrees or less. That is thought to be because the flow speed of a plating solution on a main surface of a substrate is made faster by setting the jet direction of the plating solution by the jet nozzle to have an angle closer to parallel to the main surface of the substrate. Namely, it is thought to be because a faster flow of a plating solution is generated in a wider range on the main surface of a substrate. In addition, by so setting, it is thought to be because the plating solution is made to flow at a faster flow speed inside the bottomed hole as well.

Therefore, by using a jet nozzle of the present embodiment, a surface-treated substrate with a plated layer having a desired thickness formed on the substrate surface is obtained in a shorter period of time than when using a conventional jet nozzle. Namely, electrical connection in a wiring board manufactured by using the surface-treated substrate is ensured while the rate of defects is reduced. Thus, productivity is improved. Moreover, since the deposit speed of plating is fast, the entire length of the surface treatment apparatus in a substrate transfer direction is shortened compared with a conventional type. Also, to increase the deposit speed of plating, the temperature of the plating solution and the concentration of copper ions may be increased. However, by increasing the temperature of a plating solution and the concentration of copper ions, the deterioration of the plating solution was accelerated and problems such as a shortened life span raises. By contrast, in the present embodiment, since the deposit speed of plating is increased by jetting the plating solution, the life span of the plating solution is increased without causing the plating solution to deteriorate.

As described above, the jet angle (θ) is preferred to be smaller to generate a faster flow along main surface 91 of substrate 90. However, if a jet nozzle is set to have a jet angle (θ) closer to zero degree, it is not easy to position such a nozzle in a way that the nozzle will not make contact with substrate 90. Therefore, the jet angle (θ) is preferred to be at least 15 degrees or greater.

As described so far in detail, surface treatment apparatus 1 according to the present embodiment includes a jet nozzle 30 for jetting plating solution 11 on main surfaces (91, 92) of substrate 90 inside treatment vessel 10. Then, jet nozzle 30 jets plating solution 11 in a direction diagonal to main surfaces (91, 92) of substrate 90. Accordingly, a fast flow of plating solution 11 is generated on main surfaces (91, 92) of substrate 90. Furthermore, because of such a flow of plating solution 11, an excellent flow of plating solution 11 is also formed inside bottomed hole 93 in substrate 90. Namely, the present embodiment provides a treatment apparatus capable of forming an excellent flow of plating solution 11 on the substrate surface to be surface-treated in substrate 90, and provides a method for manufacturing a surface-treated substrate.

The present embodiment simply indicates that it is an example of the present invention and does not limit the present invention. Obviously, numerous modifications and variations of the present invention are possible within a scope that does not deviate from the gist of the present invention. For example, plating solution 11 is not limited to performing copper plating, and it may also be a plating solution for performing other plating such as nickel plating. In addition, surface treatment apparatus 1 is not limited to performing plating and may perform other chemical conversion treatment such as desmearing and soft etching.

In addition, in the description provided for the above embodiment, jet direction (A) when seen in a direction perpendicular to main surface 91 is set to be parallel to the transfer direction of substrate 90. However, jet direction (A) may be diagonal to the transfer direction of substrate 90. Moreover, jet nozzle 30 may jet plating solution 11 from the downstream side toward the upstream side of the transfer direction of substrate 90, for example. Alternatively, nozzle hole 31 of jet nozzle 30 is described as a slit shape spanning continuously in a width direction of substrate 90. However, nozzle hole 31 may be divided by one or more partitions in a width direction of substrate 90. Yet alternatively, the number of nozzle holes 31 of jet nozzle 30 is not limited to two, and it may be one, or three or more.

To apply a treatment solution properly, it is desirable for the treatment solution to form an excellent flow of the treatment solution on the surface to be surface-treated. In a portion where a treatment solution is stagnant, the components of the treatment solution may be distributed unevenly and the speed of surface treatment tends to slow down. Also, a substrate to be surface-treated may have holes formed by a drill or a laser, and vias formed by performing plating on the holes. Vias are for electrically connecting wiring patterns in different conductive layers through the plated layer formed on the inner wall surfaces of the holes.

When a treatment solution is jetted in a direction perpendicular to a main surface of a substrate, a flow of the treatment solution is hard to form in a direction along the main surface of the substrate, causing the treatment solution to stagnate. Especially, stagnation of the treatment solution is more likely to occur inside a bottomed hole. For example, if a treatment solution for plating stagnates inside a hole, plating is not formed on the inner-wall surface of the bottomed hole. Namely, when a plating solution stagnates inside a bottomed hole, conduction failure may occur in a subsequently obtained wiring board.

Problems such as above may also occur when other chemical conversion treatments are employed, such as desmearing and soft etching, which are performed by jetting a treatment solution. Namely, if a treatment solution stagnates in a bottomed hole, defects may be caused in a wiring board due to the application failure of the treatment solution in the hole.

A surface treatment apparatus according to an embodiment of the present invention is capable of forming an excellent flow of a treatment solution on a substrate surface to be surface-treated, and a method for manufacturing a surface-treated substrate according to an embodiment of the present invention is capable of forming an excellent flow of a treatment solution on a substrate surface to be surface-treated.

A surface treatment apparatus according to an embodiment of the present invention provides a treatment solution and performs surface treatment on a surface of a substrate while transferring the substrate in an in-plane direction of the substrate. Such an apparatus is characterized by having a treatment vessel through which a substrate passes and in which surface treatment is performed on the substrate; and a jet section which is provided inside the treatment vessel and which jets a treatment solution from a nozzle hole onto the substrate surface. The jet direction of a treatment solution at the nozzle hole of the jet section is set to be parallel or diagonal to the substrate surface.

The jet section of the surface treatment apparatus according to an embodiment of the present invention is capable of generating a fast flow of a treatment solution on a surface of a substrate by jetting the treatment solution in a direction diagonal or parallel to the substrate surface. Thus, the apparatus is capable of forming an excellent flow of the treatment solution on the substrate surface to be surface-treated. Moreover, by generating a fast flow of the treatment solution on the substrate surface, an excellent flow of the treatment solution is also formed inside a bottomed hole or a penetrating hole of the substrate. Accordingly, since excellent surface treatment is performed on the substrate surface in a short period of time, productivity of the substrate is enhanced, the surface treatment apparatus is made smaller and the treatment solution is suppressed from deteriorating. In addition, a high-quality wiring board is manufactured from the surface-treated substrate obtained by performing surface treatment using such a surface treatment apparatus.

In the surface treatment apparatus described above, the inclination angle of the jet direction of a treatment solution at a nozzle hole of the jet section with respect to the substrate surface is preferred to be set at 15 degrees or greater but 45 degrees or less. By so setting, an excellent flow of the treatment solution is formed on the substrate surface to be surface-treated.

In the surface treatment apparatus described above, the jet direction of a treatment solution at a nozzle hole of the jet section may be set from the upstream side toward the downstream side in a transfer direction of a substrate when seen from a direction perpendicular to a substrate surface.

In addition, a method for manufacturing a surface-treated substrate according to an embodiment of the present invention includes supplying a treatment solution onto a surface of a substrate while transferring the substrate in an in-plane direction so as to perform surface treatment. Such a method is characterized by the following: a treatment solution is jetted onto a substrate surface while the substrate is passing through the inside of a treatment vessel, and the jet direction of a treatment solution at a nozzle hole is set parallel or diagonal to the substrate surface.

In the method for manufacturing a surface-treated substrate described above, the inclination angle of the jet direction of a treatment solution at a nozzle hole with respect to the substrate surface is preferred to be set at 15 degrees or greater but 45 degrees or less.

In the method for manufacturing a surface-treated substrate described above, the jet direction of a treatment solution at a nozzle hole may be set from the upstream side toward the downstream side in a transfer direction of a substrate when seen from a direction perpendicular to the substrate surface.

In the method for manufacturing a surface-treated substrate described above, a substrate having a bottomed hole on its surface may be subject to surface treatment, and a treatment solution may be such a type for performing surface treatment on the inner surface of a bottomed hole of a substrate. According to an embodiment of the present invention, an excellent flow of a treatment solution is also formed inside a bottomed hole of a substrate where a treatment solution might otherwise tend to stagnate.

A surface treatment apparatus according to an embodiment of the present invention is capable of forming an excellent flow of a treatment solution on the substrate surface to be surface-treated and provides a method for manufacturing a surface-treated substrate according to an embodiment of the present invention.

Obviously, numerous modifications and variations of the present invention are possible in light of the above teachings. It is therefore to be understood that within the scope of the appended claims, the invention may be practiced otherwise than as specifically described herein.

What is claimed is:

1. A surface treatment apparatus, comprising:
a treatment vessel configured to contain a treatment solution;
a transfer device configured to transfer a substrate through an interior portion of the treatment vessel in an in-plane direction of the substrate; and
a jet device positioned in the interior portion of the treatment vessel and configured to jet the treatment solution onto a surface of the substrate such that the surface of the substrate is treated with the treatment solution in the interior portion of the treatment vessel,
wherein the jet device has a nozzle hole configured to jet the treatment solution in a jet direction set parallel or diagonal with respect to the substrate surface.

2. A surface treatment apparatus according to claim 1, wherein the nozzle hole of the jet device is formed such that the jet direction of the nozzle hole forms an inclination angle in a range of 15° to 45° with respect to the surface of the substrate.

3. A surface treatment apparatus according to claim 1, wherein the nozzle hole of the jet device is formed such that the jet direction of the nozzle hole is directed from an upstream side to a downstream side of a transfer direction of the substrate.

4. A surface treatment apparatus according to claim 2, wherein the nozzle hole of the jet device is formed such that the jet direction of the nozzle hole is directed from an upstream side to a downstream side of a transfer direction of the substrate.

5. A surface treatment apparatus according to claim 1, wherein the transfer device comprises a plurality of transfer rollers positioned in the interior of the treatment vessel such that the substrate is transferred through the interior portion of the treatment vessel in the in-plane direction of the substrate.

6. A surface treatment apparatus according to claim 1, wherein the jet device comprises a jet nozzle having the nozzle hole, a flow channel connected to the jet nozzle and a pump configured to pump the treatment solution to the jet nozzle.

7. A surface treatment apparatus according to claim 1, wherein the jet device comprises a plurality of jet nozzles, a flow channel connected to the plurality of jet nozzles and a pump configured to pump the treatment solution to the plurality of jet nozzles, and each of the jet nozzles has the nozzle hole configured to jet the treatment solution in the jet direction set parallel or diagonal with respect to the substrate surface.

8. A surface treatment apparatus according to claim 1, wherein the jet device comprises a plurality of first jet nozzles positioned to jet the treatment solution to the surface of the substrate and a plurality of second jet nozzles positioned to jet the treatment solution to a second surface of the substrate on an opposite side with respect to the surface of the substrate.

9. A surface treatment apparatus according to claim 6, wherein the nozzle hole of the jet device is formed such that the jet direction of the nozzle hole forms an inclination angle in a range of 15° to 45° with respect to the surface of the substrate

10. A surface treatment apparatus according to claim 6, wherein the nozzle hole of the jet device is formed such that the jet direction of the nozzle hole is directed from an upstream side to a downstream side of a transfer direction of the substrate.

11. A method for producing a surface-treated substrate, comprising:
transferring a substrate in an in-plane direction through a treatment solution contained in an interior portion of a treatment vessel; and
jetting the treatment solution onto a surface of the substrate in the interior portion of the treatment vessel such that the treatment solution is jetted in a jet direction which is set parallel or diagonal with respect to the surface of the substrate.

12. A method for producing a surface-treated substrate according to claim 11, wherein the jet direction of the nozzle hole is set at an inclination angle in a range of 15° to 45° with respect to the surface of the substrate.

13. A method for producing a surface-treated substrate according to claim 11, wherein the jet direction of the nozzle hole is directed from an upstream side to a downstream side of a transfer direction of the substrate.

14. A method for producing a surface-treated substrate according to claim 12, wherein the jet direction of the nozzle hole is directed from an upstream side to a downstream side of a transfer direction of the substrate.

15. A method for producing a surface-treated substrate according to claim 11, wherein the substrate has a bottomed hole formed on the surface of the substrate, and the treatment solution is for a surface treatment on an inner surface of the bottomed hole of the substrate.

16. A method for producing a surface-treated substrate according to claim 12, wherein the substrate has a bottomed hole formed on the surface of the substrate, and the treatment solution is for a surface treatment on an inner surface of the bottomed hole of the substrate.

17. A method for producing a surface-treated substrate according to claim 13, wherein the substrate has a bottomed hole formed on the surface of the substrate, and the treatment solution is for a surface treatment on an inner surface of the bottomed hole of the substrate.

18. A method for producing a surface-treated substrate according to claim 11, wherein the treatment solution is jetted onto the surface of the substrate while the substrate is passing through the interior portion of the treatment vessel such that the treatment solution is jetted in the jet direction which is set parallel or diagonal with respect to the surface of the substrate.

19. A method for producing a surface-treated substrate according to claim 11, wherein the treatment solution is jetted from a jet device onto the surface of the substrate, the jet device is positioned in the interior portion of the treatment vessel and has a nozzle hole configured to jet the treatment solution in the jet direction set parallel or diagonal with respect to the substrate surface.

20. A method for producing a surface-treated substrate according to claim 19, wherein the nozzle hole of the jet device is formed such that the jet direction of the nozzle hole forms an inclination angle in a range of 15° to 45° with respect to the surface of the substrate.
